(19) United States
(12) Patent Application Publication
(10) Pub. No.: US 2018/0297382 A1
(43) Pub. Date: Oct. 18, 2018

(54) PAGE GAP NOZZLE SPITTING

(71) Applicant: Hewlett-Packard Development Company, L.P., Houston, TX (US)

(72) Inventors: Mark H MacKenzie, Corvallis, OR (US); Matthew A Shepherd, Vancouver, WA (US); Vanessa Verzwyvelt, Vancouver, WA (US); Bruce A Axten, Camas, WA (US); Weiyun Sun, Vancouver, WA (US)

(21) Appl. No.: 15/767,294

(22) PCT Filed: Feb. 16, 2016
(86) PCT No.: PCT/US2016/018038

§ 371 Date: Apr. 10, 2018

(51) Int. Cl. B41J 25/308; B41J 2/155; B41J 13/00

(52) U.S. Cl. CPC B41J 25/308; B41J 13/0027; B41J 2/155

(57) ABSTRACT

A method for inkjet nozzle spitting including conveying pages in a print direction along a transport through a printzone of a wide array printhead formed by a plurality of rows of nozzles disposed crosswise to the print direction, the nozzles to eject ink drops in accordance with print data. The method further includes maintaining a gap between pages as the gap moves through the printzone, and providing spit pattern data as print data to the printhead to successively activate each row of nozzles, in the print direction and in synchronism with movement of the gap, to eject ink drops from all nozzles of the row so that a position of the activated row of nozzles is maintained within the gap as the gap continuously moves through the printzone.

### BACKGROUND

Inkjet printers employ one or more printhead dies that eject drops of ink from a plurality of nozzles onto a print medium to form a desired image. Not all nozzles of each printhead are fired during each printing operation. Due to dust particles, print media fibers, and fast-drying ink employed for printing, nozzles in general, and unused nozzles in particular, can be susceptible to clogging. In order to prevent nozzle clogs and to keep nozzles healthy for subsequent printing operations, nozzles are periodically exercised (e.g. after a certain time period) by ejecting a number of ink drops, a process commonly referred to as “health spitting” or simply as “spitting.”

### BRIEF DESCRIPTION OF THE DRAWINGS

FIG. 1 is a block and schematic diagram illustrating an inkjet printing system according to one example.

FIG. 2 is a block and schematic diagram generally illustrating a wide array printhead according to one example.

FIG. 3 is a block and schematic diagram of portions of an inkjet printing system illustrating nozzle spitting according to one example.

FIG. 4 is a block and schematic diagram of portions of an inkjet printing system illustrating nozzle spitting according to one example.

FIG. 5 is a flow diagram illustrating a method of nozzle spitting according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Inkjet printers employ one or more printhead dies that eject drops of ink from a plurality of nozzles onto a print medium to form a desired image. A wide array printhead includes an array of nozzles arranged to span across a full width of a printing path. According to one wide array printhead implementation, a plurality of printhead dies are mounted on a stationary support or bar, commonly referred to as a printbar, with the plurality of printhead dies being arranged in a staggered and overlapping fashion and spanning a width of a printing path crosswise to a printing direction. The nozzles of printhead dies together form a printzone adjacent to the printbar into which drops of ink are ejected from the plurality of nozzles onto a print medium, the printzone having a width or “writing width” in the printing direction. During printing, as print medium is continuously advanced in the printing direction through the printzone, the nozzles of the plurality of printhead dies are fired in a controlled sequence, which is synchronized with movement of the print medium, to eject drops of ink across the width of the print medium to form the desired image thereon.

Not all nozzles of each printhead are fired during each printing operation. Due to dust particles, print media fibers, fast-drying ink employed for printing, extended durations between firing, and any number of other factors, nozzles in general, and unused nozzles in particular, can be susceptible to clogging. In order to prevent nozzle clogs and to keep nozzles healthy for subsequent printing operations, nozzles are periodically exercised (e.g. after a certain time period) by ejecting a number of ink drops, a process commonly referred to as “maintenance spitting” or simply as “spitting.”

One spitting technique for a wide array printer includes activating or firing all nozzles of each printhead to simultaneously eject a series of one or more ink drops into a page gap between successive pages of print media onto which image data is to be printed as part of a printing operation. According to such technique, after printing is completed for a first or upstream page, referred to herein as page N, page N is advanced in the printing direction until a trailing edge of page N exits the printzone and then stopped. A next or downstream page, referred to herein as page N+1, is advanced and stopped so that a leading edge of page N+1 is short of the printzone, thereby forming a gap between pages N and N+1 that is positioned in the printzone. All nozzles of the printbar are then simultaneously or sequentially activated or fired to spit a desired number of ink drops into the page gap. After nozzle spitting is completed, conveyance of pages N and N+1 along the printing path is resumed with the printhead subsequently printing image data on sheet N+1. When spitting is required again, say after page N+1, the process is repeated.

Typically, the nozzles of a printhead are arranged in an array of rows and columns, with the rows and columns of multiple printheads being arranged so as together form rows and columns of the printbar of a wide array printhead, with a first row of printbar nozzles disposed furthest in an upstream direction (relative to the printing direction) and a last row of printbar nozzles being disposed furthest in a downstream direction (relative to the printing direction). Each row of printbar nozzles has a drop zone having a zone width in the upstream direction and zone width in downstream direction in which ink drops, or portions of ink drops, may be present when ink drops are ejected from nozzles of the row.

In order to prevent ink from inadvertently being disposed along a trailing edge of page N and along a leading edge of page N+1 during nozzle spitting, the trailing edge of page N is spaced from the last row of nozzles of the printbar by at least the drop zone width in the downstream direction, and the leading edge of page N+1 is spaced from the first row of nozzles of the printbar by at least the drop zone width in the upstream direction. As such, when performing a spitting operation a total gap distance between the trailing edge of page N and the leading edge of page N+1 is equal to the width of the printzone plus two times the drop zone width.

One performance metric for printers is throughput (i.e., a number of pages that can be printed in a given duration, such as pages per minute, for example). According to the above-described conventional spitting technique, pausing the transport of pages N and N+1 along the transport path during the spitting operation, and the gap distance maintained between pages N and N+1 during the spitting operation adversely impact printer throughput (i.e. the longer the pause and the greater the gap distance, the less the printer throughput).

FIG. 1 is a block and schematic diagram generally illustrating an inkjet printing system 100 employing a gap spitting architecture, according to examples of the present disclosure, which reduces gap distances between successive pages and maintains advancement of pages along the transport path during nozzle gap spitting (i.e. eliminates stoppage of pages during spitting), thereby improving printer throughput relative to conventional spitting techniques.

Inkjet printing system 100 includes an inkjet printhead assembly 102, an ink supply assembly 104 including an ink storage reservoir 107, a mounting assembly 106, a media transport assembly 108, an electronic controller 110, and at least one power supply 112 that provides power to the various electrical components of inkjet printing system 100. Inkjet printhead assembly 102 includes one or more printhead dies 114, each of which ejects drops of ink through a plurality of orifices or nozzles 116 toward a page of print media 118 (referred to herein simply as page 118) within a printzone 120 in accordance with print data so as to print a desired image on sheet 118.

In one example, as will be described in greater detail below, inkjet printhead assembly 102 is a wide array printhead having a plurality of printhead dies 114 fixedly mounted on a stationary bar spanning a transport path along which page 118 is conveyed by media transport assembly 118, and being disposed crosswise to a print direction. Printhead assembly 102, according to such a configuration, is also referred to as printbar 102. According to such example, mounting assembly 106 maintains inkjet printhead assembly 102 at a fixed position relative to media transport assembly 108, with media transport assembly 108 moving sheet 118 relative to stationary inkjet printhead assembly 102. As page 118 is transported through printzone 120, nozzles 116 of printhead dies 114 are sequenced in accordance with image data to eject ink drops to form a desired image (characters, symbols, graphics, etc.) on page 118.

In operation, ink typically flows from reservoir 107 to inkjet printhead assembly 102, with ink supply assembly 104 and inkjet printhead assembly 102 forming either a one-way ink delivery system or a recirculating ink delivery system. In a one-way ink delivery system, all of the ink supplied to inkjet printhead assembly 102 is consumed during printing. However, in a recirculating ink delivery system, only a portion of the ink supplied to printhead assembly 102 is consumed during printing, with ink not consumed during printing being returned to supply assembly 104. Reservoir 107 may be removed, replaced, and/or refilled.

In one example, ink supply assembly 104 supplies ink under positive pressure through an ink conditioning assembly 111 to inkjet printhead assembly 102 via an interface connection, such as a supply tube. Ink supply assembly includes, for example, a reservoir, pumps, and pressure regulators. Conditioning in the ink conditioning assembly may include filtering, pre-heating, pressure surge absorption, and degassing, for example. Ink is drawn under negative pressure from printhead assembly 102 to the ink supply assembly 104. The pressure difference between an inlet and an outlet to printhead assembly 102 is selected to achieve correct backpressure at nozzles 116, and is typically a negative pressure between negative 1 and negative 10 inches of H2O.

Electronic controller 110 includes a processor (CPU) 128, a memory 130, firmware, software, and other electronics for communicating with and controlling inkjet printhead assembly 102, mounting assembly 106, and media transport assembly 108. Memory 130 can include volatile (e.g. RAM) and nonvolatile (e.g. ROM, hard disk, floppy disk, CD-ROM, etc.) memory components including computer/processor readable media that provide for storage of computer/processor executable coded instructions, data structures, program modules, and other data for inkjet printing system 100.

Electronic controller 110 receives data 124 from a host system, such as a computer, and temporarily stores data 124 in a memory. Typically, data 124 is sent to inkjet printing system 100 along an electronic, infrared, optical, or other information transfer path. Data 124 represents, for example, a document and/or file to be printed. As such, data 124 forms a print job for inkjet printing system 100 and includes one or more print job commands and/or command parameters. In one implementation, electronic controller 110 controls inkjet printhead assembly 102 for the ejection of ink drops from nozzles 116 of printhead dies 114. Electronic controller 110 defines a pattern of ejected ink drops to form characters, symbols, and/or other graphics or images on sheet 118 based on the print job commands and/or command parameters from data 124.

In one example, electronic controller 110 includes a spit module 140 for implementing for implementing nozzle health spitting in accordance with one example of the present disclosure. In one example, spit module 140 may be implemented as a combination of hardware/firmware. In one example, spit module 140 may be implemented as computer executable instructions stored in a memory, such as memory 130 (as illustrated by dashed lines in FIG. 1), In one example, spit module 140 includes spit data 142 which serves as print data for controlling the spitting of the nozzles of the printheads 114 of printbar 102 during a spitting operation, as will be described in greater detail below.

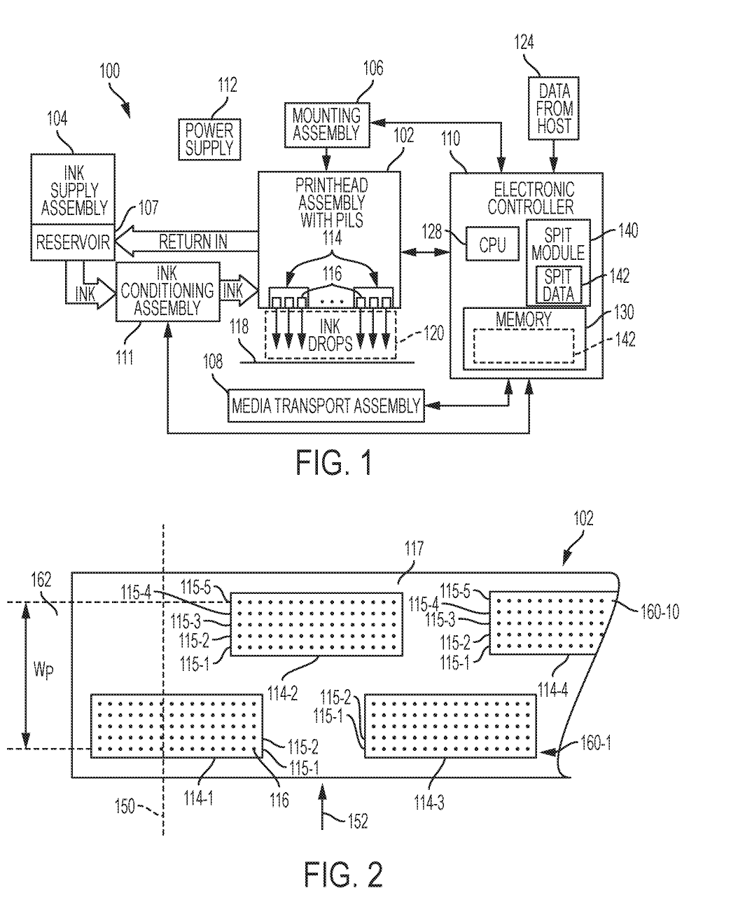

FIG. 2 is a block and schematic diagram illustrating generally a portion of a wide array printhead 102, or printbar 102, according to one example. Printbar 102 includes a plurality of printhead dies 114 (such illustrated as by printhead dies 114-1 to 114-4 in FIG. 2), with each printhead die 114 including a plurality of rows 115 of nozzles 116 (such as illustrated by nozzle rows 115-1 and 115-2 of printhead die 114-1). Printhead dies 114 are mounted to a support or bar 117 so as to form printbar 102. Printhead dies are mounted in a staggered and overlapping fashion across a transport path 150 along which pages 118 are transported in a print direction 152, with the rows 115 of nozzles disposed orthogonally to print direction 152. Together, rows of nozzles 115 of printhead dies 114 form rows of nozzles of printbar 102. For example, rows of nozzles 115-1 of printhead dies 114-1 and 114-3 form a portion of a first row of nozzles 160-1 of printbar 102 which is closest to the upstream side of printbar 102 (relative to print direction 152), and rows of nozzles 115-5 of printhead dies 114-2 and 114-4 form a portion of a last row of nozzles 160-10 of printbar 102 which is closest to the downstream side of printbar 102 (relative to print direction 152). Together, the rows of nozzles 116 of the plurality of printhead dies 114 form a printzone 162 having a width WP in the print direction 152.

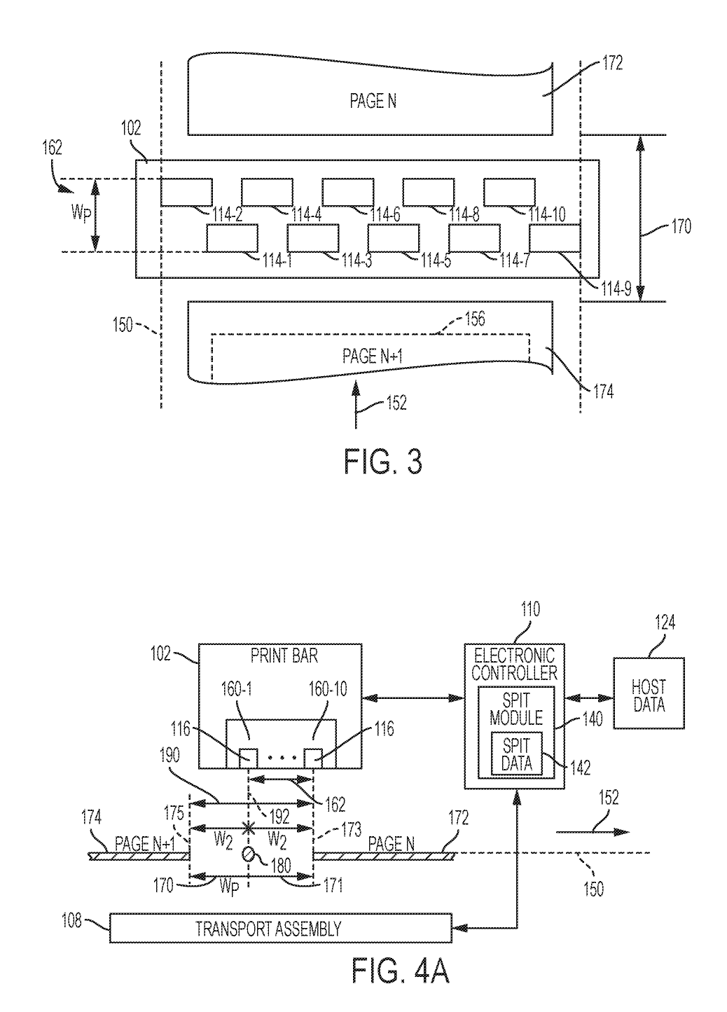

FIG. 3 is a block and schematic diagram illustrating portions of inkjet printing system 100, according to one example, and illustrating the transport of downstream page 172 (page N) and upstream page 174 (page N+1) along transport path 150 in printing direction 152 in relation to printbar 102. As illustrated by FIG. 3, printing of a desired image on page N by printbar 102 has been completed, with a desired image to next be printed on upstream page N+1. As illustrated by FIG. 3, a page gap 170 between pages N and N+1 is positioned to include printzone 162 of printbar 102, with printzone 162 illustrated as having a width in the print direction of W_{P}.

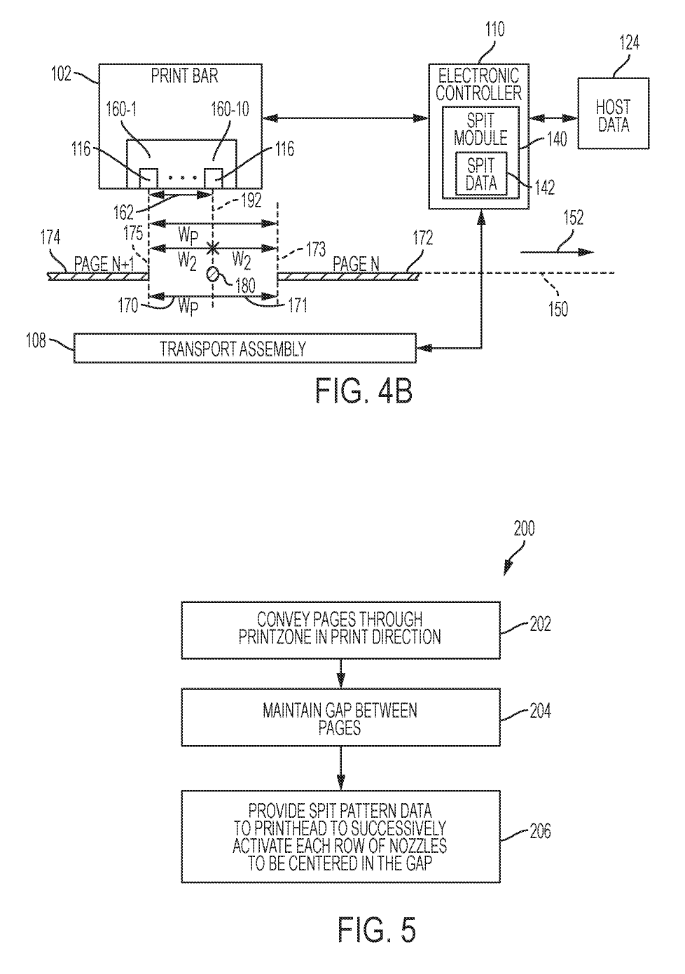

FIGS. 4A and 43 show portions of inkjet printing system 100 and illustrate a nozzle spitting operation for spitting nozzles 116 of printbar 102 into page gap 170 according to examples of the present disclosure. Pages N and N+1 are transported in print direction 152 along transport path 150 by transport assembly 108 (e.g. a plurality of roller pairs). As illustrated, according to one example, after printbar 102 has completed a printing operation to print an image on downstream page N in accordance with print data received from electronic controller 110 based on host image data 124, spit module 140 (also referred to as spit controller 140) directs transport assembly to maintain page gap 170 between a trailing edge 173 of downstream page N and a leading edge 175 of upstream page N+1 and to continuously convey gap 170 through printzone 162 (boundaries of which are illustrated by vertical dashed lines) at a desired speed (e.g. print speed).

According to one example, as page gap 170 passes through printzone 162, spit controller 140 provides spit pattern data 142 as print data to printbar 102 which directs printbar 102 to successively fire each row of nozzles 160 in the print direction so as eject ink drops, such as ink drop 180, in the form of a line within page gap 170 as page gap 170 moves through printzone 162. In one example, each row of nozzles 160 is successively fired such that the row of nozzles being fired is along a centerline 171 of page 170 as page gap 170 moves through printzone 162.

As described above, each row of nozzles 160 has a drop zone extending both upstream and downstream along transport path 150 (relative to print direction 152) from a spit plane, such as illustrated drop zone 190 of the row of nozzles 160-1 extending from spit plane 192. As illustrated, the drop zone 190 of each row of nozzles is centered on the row (i.e., on the corresponding spit plane) and extends by a zone width W_{Z} in both the upstream and downstream directions along transport path 150, In one example, the width of the drop zone 190 may vary for each row of nozzles 160. For instance, in one case, the width of the drop zone 190 of the last row of nozzles 160-10 may be greater than the width of the drop zone 190 of the first row of nozzles 160-1.

According to one example, spit controller 140 directs transport assembly 108 to maintain page gap 170 with a width W_{P} at least equal to a total width of a drop zone 190 (i.e., 2×zone width W_{Z}) of the row of nozzles 160 having the widest drop zone 190. For example, if the last row of nozzles 160-10 of printhead 102 has the widest drop zone 190, spit controller 140 directs transport assembly 108 to maintain page gap 170 with a width WP at least equal to the width of drop zone 190 of the last row of nozzles 160-10. In one instance, as page gap 170 moves through print zone 162, spit controller 140 directs transport assembly 108 to maintain page gap 170 such that the ink drops 180 of the row of nozzles 160 being fired during a spitting operation is positioned within gap 170. In one example, as illustrated, spit controller 140 directs transport assembly 108 to maintain page gap 170 at a width W_{P} equal to the total width of drop zone 190 and centered on the spit plane of the row of nozzles 160 being fired (i.e. the active row) such that a gap from trailing edge 173 of downstream page N and a gap from leading edge 175 of upstream page N+1 to the spit plane are each equal to the zone width W_{Z}. According to such example, both downstream page N and upstream page N+1 are spaced at a minimum safe distance from printhead 102 during nozzle spitting to avoid inadvertent deposition of ink particles thereon.

As page gap 170 is continuously advanced through printzone 162, successive firing of rows 160 of printhead 102, in synchronism with movement of page gap 170 ensure that the active row of nozzles ejects ink drops at the centerline 171 of page gap 170, as illustrated by FIG. 4B, where the last row of nozzles 160-10 is illustrated as spitting ink drops into gap 170.

According to one example, spit controller 140 inserts spit pattern data 142 into print data for upstream page N+1, wherein the spit pattern data 142 is added to the top of the print data for upstream page N+1 at distance from leading edge 175 (also referred to as the “top of form”) equal to the zone width W_{Z}. In one example, spit pattern data 142 is in the form of a line printed by all nozzles 116 of printhead 102, each nozzle spitting a desired number of ink drops to ensure nozzle health. According to one example, spit controller 140 provides spit pattern data 142 to printhead 102 separate from print data for pages, such as page N+1.

By maintaining continuous movement of page gap 170 through printzone 162 during a page gap spitting operation (i.e. continuous movement pages N and N+1), and by maintaining the minimum safe distance between spit plane 192 and both the trailing edge 173 of upstream page N and the leading edge 175 of upstream page N+1, page gap nozzle spitting in accordance with the present disclosure maximizes printer throughput relative to conventional page gap spitting techniques, while maintaining print quality.

FIG. 5 is a flow diagram illustrating a method 200 of inkjet nozzle spitting for a wide array printhead according to one example. At 202, method 200 includes conveying pages in a print direction along a transport through a printzone of a wide array printhead formed by a plurality of rows of nozzles disposed crosswise to the print direction, the nozzles to eject ink drops in accordance with print data, such as illustrated by pages N and N+1 being conveyed through printzone 190 of printhead 102 of FIGS. 4A and 4B, for example.

At 204, the method includes maintaining the gap between pages as the gap moves through the printzone, such as illustrated by gap 170 being maintained between pages N and N+1 through printzone 190 in FIGS. 4A and 4B, for example.

At 206, the method includes providing spit pattern data as print data to the printhead to successively activate each row of nozzles, in the print direction and in synchronism with movement of the gap, to eject ink drops from all nozzles of the row so that the activated row of nozzles is centered in the gap as the gap continuously moves through the printzone, such as illustrated by rows of nozzles 160-1 to 160-10 of printhead 102 of FIGS. 4A and 4B being successively activated in print direction 152 so as to eject ink drops 180 along the centerline 171 of gap 170 as gap 170 moves through printzone 162, for example.

In one example, each row of nozzles of the printhead has a drop zone with a zone width in the print direction, wherein maintaining a gap between pages includes maintaining a gap having a gap width in the print direction at least as wide as the zone width. For example, the gap is equal to the zone width of the drop zone in the print direction.

In one example, each gap is formed by a trailing edge of an upstream page, relative to the print direction, and a leading edge of a downstream page, wherein the method includes providing spit pattern data by inserting spit pattern data as print data into print data for the downstream page, the spit pattern data having a form of one or more lines inserted ahead of the leading edge in the print direction.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method for inkjet nozzle spitting comprising:
conveying pages in a print direction along a transport through a printzone of a wide array printhead formed by a plurality of rows of nozzles disposed crosswise to the print direction, the nozzles to eject ink drops in accordance with print data;
maintaining a gap between pages as the gap continuously moves through the printzone;
providing spit pattern data as print data to the printhead to successively activate each row of nozzles, in the print direction and in synchronism with movement of the gap, to eject ink drops from all nozzles of the row so that a position of the activated row of nozzles is maintained within the gap as the gap continuously moves through the printzone.

2. The method of claim 1, each row of nozzles having a drop zone with a zone width in the print direction, including maintaining a gap between pages having a gap width in the print direction at least equal to the zone width of drop zone of the row of nozzles having the widest drop zone.

3. The method of claim 2, including maintaining the gap width equal to the zone width of the drop zone having the widest zone width.

4. The method of claim 1, each gap formed by a trailing edge of an upstream page, relative to the print direction, and a leading edge of a downstream page, the method including providing spit pattern data by inserting spit pattern data as print data into print data for the downstream page, the spit pattern data having a form of a line at a distance of one-half a width of the gap ahead of the leading edge in the print direction.

5. The method of claim 1, each gap formed between an upstream page and a downstream page relative to the print direction, the method including providing spit pattern data as print data to the printhead after completion of printing of print data to each upstream page.

6. A printer comprising:
a wide array printhead including nozzles for ejecting ink drops in accordance with print data, the nozzles disposed in rows across a page transport path crosswise to a print direction and forming a printzone;
a transport assembly conveying pages in the print direction along the transport path and maintaining a gap between pages as the gap passes through the printzone; and
a spit controller providing spit pattern data as print data to the printhead to successively activate each row of nozzles in the print direction to eject ink drops in synchronism with page movement so the activated row of nozzles is maintained within the gap as the gap continuously moves through the printzone.

7. The printer of claim 6, each gap formed by a trailing edge of an upstream page relative to the print direction and a leading edge of a downstream page, the spit controller inserting spit pattern data as print data into print data for the downstream page, the spit data having a form of a line positioned within the gap.

8. The printer of claim 6, each gap formed between an upstream page relative to the print direction and a downstream page, the spit controller providing the spit pattern data as print data to the printhead separate from print data for pages.

9. The printer of claim 6, each gap formed by between an upstream page relative to the print direction and a downstream page, the spit controller providing spit data to the printhead after each upstream page.

10. The printer of claim 6, each row of nozzles having a drop zone with a zone width in the print direction, the gap at least equal to the zone width.

11. The printer of claim 10, the gap being at least equal to the zone width of the drop zone of the row of nozzles having the widest drop zone.

12. The printer of claim 6, the spit data executed by the printhead so that the nozzles eject ink drops to print a line.

13. The printer of claim 6, the spit data activating all nozzles of each row to eject a desired number of ink drops.

14. A printer comprising:
a wide array printhead including a plurality of nozzles for ejecting ink drops in accordance with print data, the printhead disposed across a page transport path crosswise to a print direction and forming a printzone;
a transport assembly conveying pages in the print direction along the transport path;
a spit controller directing the transport assembly to maintain a gap having a desired width between pages as the gap passes through the printzone and providing spit pattern data as print data to the printhead directing the printhead to eject a desired number of ink drops from each nozzle to print a line centered in the gap as the gap continuously moves through the printzone.

15. The printer of claim 14, the plurality of nozzles arranged in a plurality of row disposed across the page transport path, each row of nozzles having a drop zone with a zone width in the print direction, the spit controller directing the transport assembly to maintain the desired width of the gap at least equal to the zone width of the drop zone of the row of nozzles having the widest drop zone.
